(19) United States
(12) Patent Application Publication
(10) Pub. No.: US 2020/0307514 A1
(43) Pub. Date: Oct. 1, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Katsuyasu Yamane, Wako-shi (JP); Yasushi Shoda, Wako-shi (JP); Junpei Noguchi, Wako-shi (JP); Yuki Hara, Wako-shi (JP); Yoshitaka Mimura, Wako-shi (JP); Hiroshi Yamanaka, Wako-shi (JP); Ryoma Taguchi, Tokyo (JP); Yuta Takada, Tokyo (JP); Chie Sugihara, Tokyo (JP); Yuki Motegi, Tokyo (JP); Tsubasa Shibauchi, Tokyo (JP)

(21) Appl. No.: 16/816,304

(22) Filed: Mar. 12, 2020

(30) Foreign Application Priority Data
Mar. 27, 2019 (JP) 2019-060020

(51) Int. Cl. B60R 25/20; B60R 25/31; B60R 25/01; G05D 1/02

(52) U.S. Cl. CPC B60R 25/20; G05D 1/0212; B60R 25/01; B60R 25/31

(57) ABSTRACT

A vehicle control device includes a recognizer configured to recognize a surrounding environment of a vehicle on the basis of a detection result of a detector configured to detect a situation outside the vehicle, a driving controller configured to perform at least one of speed control and steering control of the vehicle on the basis of a recognition result of the recognizer, and a door controller configured to perform opening control for opening a door of the vehicle. The door controller starts opening control for opening the door of the vehicle if the recognizer has recognized a predetermined motion of a user when the vehicle travels according to control of the driving controller.

### CROSS-REFERENCE TO RELATED APPLICATION

Priority is claimed on Japanese Patent Application No. 2019-060020, filed Mar. 27, 2019, the content of which is incorporated herein by reference.

### BACKGROUND

### Field of the Invention

The present invention relates to a vehicle control device, a vehicle control method, and a storage medium.

### Description of Related Art

In recent years, research has been conducted on automatedly controlling vehicles. For example, technology for detecting a gesture of a person using a sensor provided on a surface of a door and causing a door to be opened or closed in accordance with details of the detected gesture when a user performs a predetermined gesture on a vehicle parked in a parking lot is known (Japanese Unexamined Patent Application, First Publication No. 2013-007171).

Technology for supplying power when a driver holding an electronic key which transmits a radio signal approaches an automated driving vehicle that is parked in a parking lot and causing the automated driving vehicle to execute behavior represented by a gesture when it is recognized that a gesture for issuing a remote operation instruction has been performed is known (Japanese Unexamined Patent Application, First Publication No. 2017-121865).

### SUMMARY

However, conventional technologies are all intended for parked vehicles and a process of performing any door control in accordance with a gesture performed on a vehicle which is traveling is not taken into account and convenience is insufficient in the conventional technologies.

The present invention has been made in view of such circumstances, and an objective of the present invention is to provide a vehicle control device, a vehicle control method, and a storage medium capable of improving the convenience of a user who gets into a vehicle that has traveled.

A vehicle control device, a vehicle control method, and a storage medium according to the present invention adopt the following configurations.

(1): According to an aspect of the present invention, there is provided a vehicle control device including: a recognizer configured to recognize a surrounding environment of a vehicle on the basis of a detection result of a detector configured to detect a situation outside the vehicle; a driving controller configured to perform at least one of speed control and steering control of the vehicle on the basis of a recognition result of the recognizer; and a door controller configured to perform opening control for opening a door of the vehicle, wherein the door controller starts the opening control for opening the door of the vehicle if the recognizer has recognized a predetermined motion of a user when the vehicle travels according to control of the driving controller.

(2): In the above-described aspect (1), the driving controller starts an action representing that the vehicle approaches the user when the recognizer has recognized a first action of the user associated with the opening control, and the driving controller changes a stop position determined in accordance with a position of the user on the basis of a second action when the recognizer has recognized the second action different from the first action of the user after the action representing that the vehicle approaches the user started.

(3): In the above-described aspect (2), the first action is an action for causing the vehicle to authenticate a person preregistered as a user of the vehicle, and the second action is an action for indicating a stop position of the vehicle to the vehicle.

(4): In the above-described aspect (2), the second action includes a motion of the user approaching the vehicle.

(5): In the above-described aspect (2), the recognizer improves recognition accuracy of the first action as compared with the second action.

(6): In the above-described aspect (2), the driving controller changes the stop position on the basis of the position of the user when the recognizer has not recognized the second action.

(7): In the above-described aspect (2), when the stop position is changed on the basis of the second action, the door controller causes the opening control to be completed at a timing when the vehicle arrives at the changed stop position.

(8): In the above-described aspect (2), when the second action is not recognized and the recognizer recognizes that the user has luggage or has a human or animal in his or her arms, the driving controller changes the stop position determined in accordance with the position of the user.

(9): In the above-described aspect (1), when the vehicle has arrived at the stop position earlier than the user, the door controller starts the opening control at a timing when the user has approached the vehicle.

(10): In the above-described aspect (1), when the door is opened by moving outward about a fulcrum, the door controller unlocks the door and puts the door in a half-closed state.

(11): In the above-described aspect (1), when the door is opened or closed by moving along a vehicle body of the vehicle, the door controller unlocks the door and moves the door by a predetermined amount.

(12): In the above-described aspect (11), when an occupant recognition device mounted on the vehicle has recognized a passenger of the vehicle, the door controller unlocks the door and does not move the door.

(13): According to an aspect of the present invention, there is provided a vehicle control method including: recognizing, by a computer mounted on a vehicle, a surrounding environment of the vehicle on the basis of a detection result of a detector configured to detect a situation outside the vehicle; performing, by the computer mounted on the vehicle, at least one of speed control and steering control of the vehicle on the basis of a recognition result; and starting, by the computer mounted on the vehicle, opening control for opening a door of the vehicle if a predetermined motion of a user has been recognized.

(14): According to an aspect of the present invention, there is provided a computer-readable non-transitory storage medium storing a program for causing a computer mounted on a vehicle to: recognize a surrounding environment of a vehicle on the basis of a detection result of a detector configured to detect a situation outside the vehicle; perform at least one of speed control and steering control of the vehicle on the basis of a recognition result; and start opening control for opening a door of the vehicle if a predetermined motion of a user has been recognized.

According to the aspects (1) to (14), it is possible to improve the convenience of a user who gets into a vehicle that has traveled.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram schematically showing a scene in which a self-traveling parking event is executed.

FIG. 4 is a diagram showing an example of a configuration of a parking lot management device.

FIG. 5 is a diagram shown to describe an example of a scene in which a user gets into a host vehicle.

FIG. 6 is a flowchart showing an example of a process associated with a first action.

FIG. 7 is a flowchart showing an example of a process associated with a second action.

FIG. 8 is a diagram showing a hardware configuration of an automated driving control device according to the embodiment.

### DESCRIPTION OF EMBODIMENTS

Embodiments of a vehicle control device, a vehicle control method, and a storage medium of the present invention will be described below with reference to the drawings. Although a case in which left-hand traffic regulations are applied will be described, it is only necessary to reverse the left and right when right-hand traffic regulations are applied.

### [Overall Configuration]

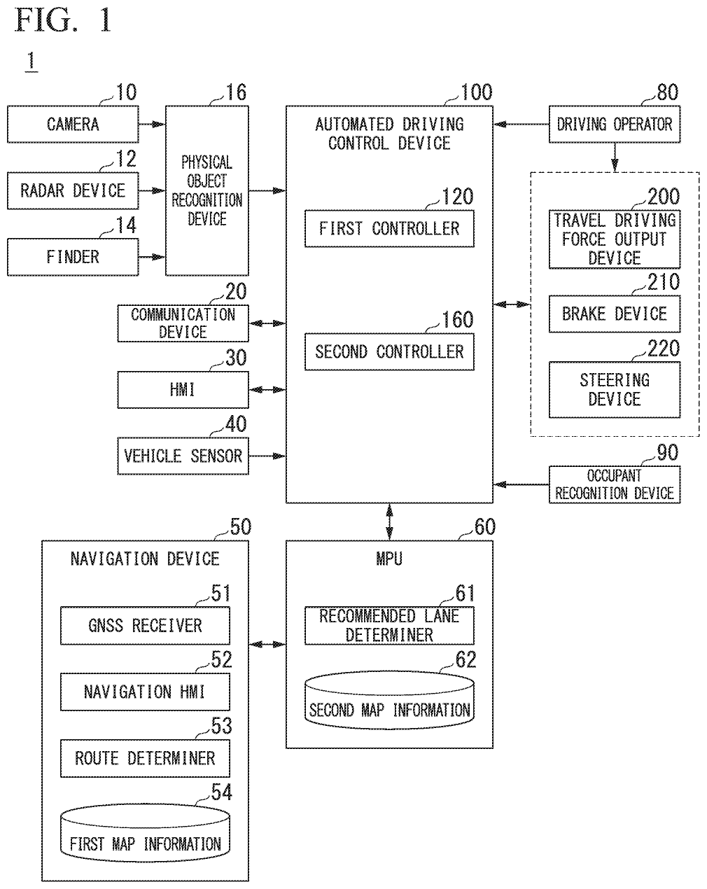

FIG. 1 is a configuration diagram of a vehicle system 1 using a vehicle control device according to an embodiment. For example, a vehicle on which the vehicle system 1 is mounted is, for example, a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power from an electric power generator connected to the internal combustion engine or discharge electric power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operator 80, an occupant recognition device 90, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network.

The configuration shown in FIG. 1 is merely an example, a part of the configuration may be omitted, and another configuration may be further added.

For example, the camera 10 is a digital camera using a solid-state imaging element such as a charge coupled device (CCD) or a complementary metal oxide semiconductor (CMOS). The camera 10 is attached to any position on the vehicle (hereinafter, a host vehicle M) on which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position on the host vehicle M.

The physical object recognition device 16 performs a sensor fusion process on detection results of some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with another vehicle or a parking lot management device (to be described below) existing in the vicinity of the host vehicle M or various types of servers using, for example, a cellular network, a Wi-Fi network, Bluetooth (registered trademark), a dedicated short range communication (DSRC), or the like.

The HMI 30 presents various types of information to an occupant of the host vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. For example, the navigation device 50 may be implemented by a function of a terminal device such as a smartphone or a tablet terminal possessed by the occupant. The navigation device 50 may transmit a current position and a destination to the navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, or the like. The second map information 62 may include road information, traffic regulations information, address information (an address/zip code), facility information, telephone number information, and the like. The second map information 62 may be updated at any time when the communication device 20 communicates with another device.

For example, the driving operator 80 includes an accelerator pedal, a brake pedal, a shift lever, a steering wheel, a steering wheel variant, a joystick, and other operators. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The occupant recognition device 90 includes, for example, a seating sensor, a vehicle interior camera, a biometric authentication system, an image recognition device, and the like. The seating sensor includes a pressure sensor provided below a seat, a tension sensor attached to a seat belt, and the like. The vehicle interior camera is a charge coupled device (CCD) camera or a complementary metal oxide semiconductor (CMOS) camera provided in the interior of the vehicle. The image recognition device analyzes an image of the vehicle interior camera and recognizes the presence or absence of an occupant for each seat, a face direction, and the like.

The automated driving control device 100 includes, for example, a first controller 120 and a second controller 160. Each of the first controller 120 and the second controller 160 is implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the automated driving control device 100 (a storage device including a non-transitory storage medium) or may be installed in the HDD or the flash memory of the automated driving control device 100 when the program is stored in a removable storage medium such as a DVD or a CD-ROM and the storage medium (the non-transitory storage medium) is mounted in a drive device.

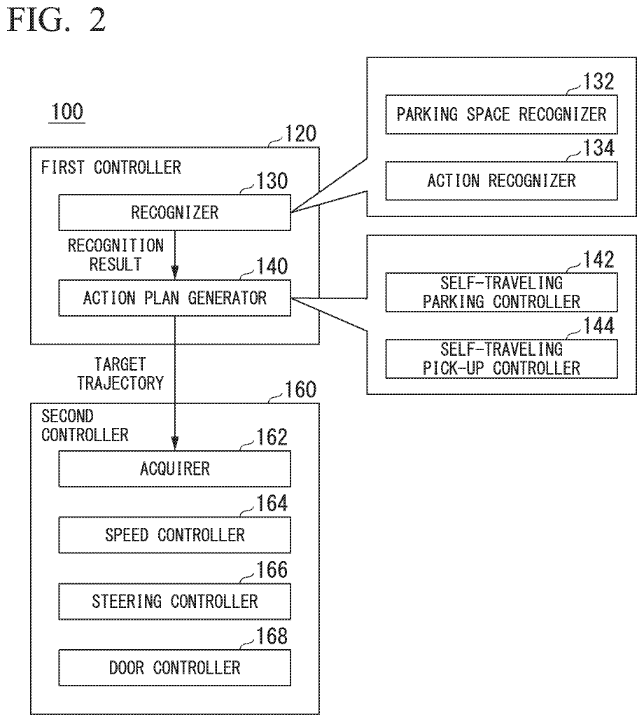

FIG. 2 is a functional configuration diagram of the first controller 120 and the second controller 160. The first controller 120 includes, for example, a recognizer 130, and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 recognizes a state such as a position, velocity, or acceleration of a physical object present in the vicinity of the host vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane in which the host vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the host vehicle M recognized from an image captured by the camera 10. The recognizer 130 may recognize a travel lane by recognizing a traveling path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. The recognizer 130 recognizes a temporary stop line, an obstacle, red traffic light, a toll gate, and other road events.

When the travel lane is recognized, the recognizer 130 recognizes a position or orientation of the host vehicle M with respect to the travel lane. For example, the recognizer 130 may recognize a gap of a reference point of the host vehicle M from the center of the lane and an angle formed with respect to a line connecting the center of the lane in the travel direction of the host vehicle M as a relative position and orientation of the host vehicle M related to the travel lane. Alternatively, the recognizer 130 may recognize a position of the reference point of the host vehicle M related to one side end portion (a road dividing line or a road boundary) of the travel lane or the like as a relative position of the host vehicle M related to the travel lane.

The recognizer 130 includes a parking space recognizer 132 and an action recognizer 134 that are activated in a self-traveling parking event to be described below. Details of functions of the parking space recognizer 132 and the action recognizer 134 will be described below.

The action plan generator 140 generates a future target trajectory along which the host vehicle M automatically travels (independently of a driver's operation) so that the host vehicle M can generally travel in the recommended lane determined by the recommended lane determiner 61 and further cope with a surrounding situation of the host vehicle M. For example, the target trajectory includes a speed element. For example, the target trajectory is represented by sequentially arranging points (trajectory points) at which the host vehicle M is required to arrive. The trajectory point is a point where the host vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the host vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following traveling event, a lane change event, a branching event, a merging event, a takeover event, a self-traveling parking event for parking the vehicle according to unmanned traveling in valet parking or the like, and the like. The action plan generator 140 generates a target trajectory according to the activated event. The action plan generator 140 includes a self-traveling parking controller 142 that is activated when the self-traveling parking event is executed and a self-traveling pick-up controller 144 that is activated when a self-traveling pick-up event is executed. Details of the functions of the self-traveling parking controller 142 and the self-traveling pick-up controller 144 will be described below.

The second controller 160 controls the travel driving force output device 200, the brake device 210, and the steering device 220 so that the host vehicle M passes through the target trajectory generated by the action plan generator 140 at a scheduled time.

The second controller 160 includes, for example, an acquirer 162, a speed controller 164, a steering controller 166, and a door controller 168. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the host vehicle M and feedback control based on a deviation from the target trajectory in combination. The door controller 168 will be described below.

Returning to FIG. 1, the travel driving force output device 200 outputs a travel driving force (torque) for enabling the vehicle to travel to driving wheels. For example, the travel driving force output device 200 may include a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operator 80 to the cylinder via a master cylinder as a backup. The brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operator 80 to cause the direction of the steerable wheels to be changed.

### [Self-Traveling Parking Event-Time of Entering]

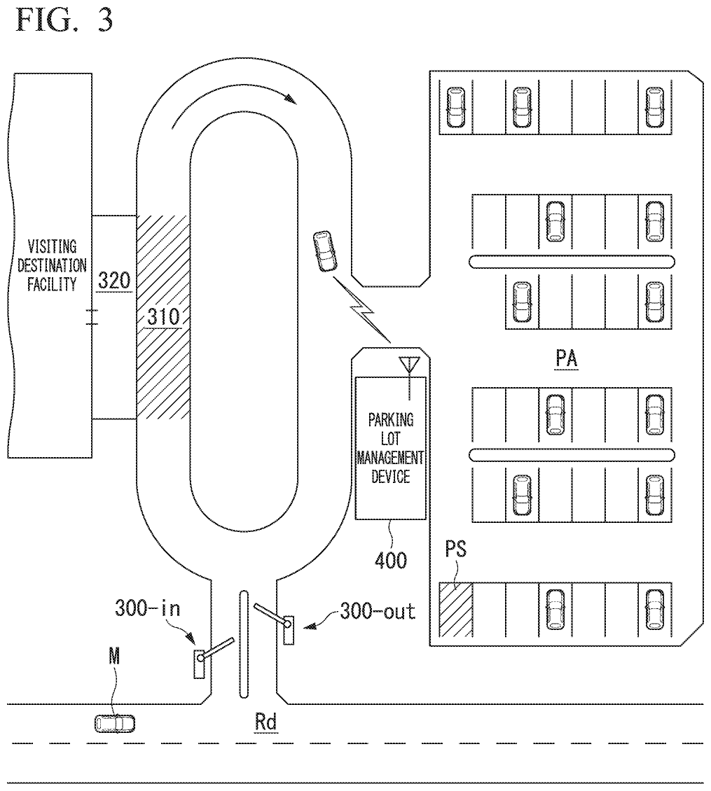

For example, the self-traveling parking controller 142 causes the host vehicle M to be parked within a parking space in the second parking area on the basis of information acquired from the parking lot management device 400 by means of the communication device 20. FIG. 3 is a diagram schematically showing a scene in which a self-traveling parking event is executed. Gates 300-In and 300-out are provided on a route from a road Rd to a visiting destination facility. The host vehicle M moves to a stopping area 310 through the gate 300-in according to manual driving or automated driving. The stopping area 310 faces a getting-into/out area 320 connected to the visiting destination facility. The getting-into/out area 320 is provided with eaves for avoiding rain and snow.

After the user gets out of the host vehicle M in the stopping area 310, the host vehicle M performs automated driving in an unmanned manner and starts a self-traveling parking event in which the host vehicle M moves to the parking space PS within the parking lot PA. A start trigger of the self-traveling parking event may be, for example, any operation of the user or may be a predetermined signal wirelessly received from the parking lot management device 400. When the self-traveling parking event starts, the self-traveling parking controller 142 controls the communication device 20 so that the communication device 20 transmits a parking request to the parking lot management device 400. The host vehicle M moves from the stopping area 310 to the parking lot PA in accordance with the guidance of the parking lot management device 400 or while performing sensing on its own.

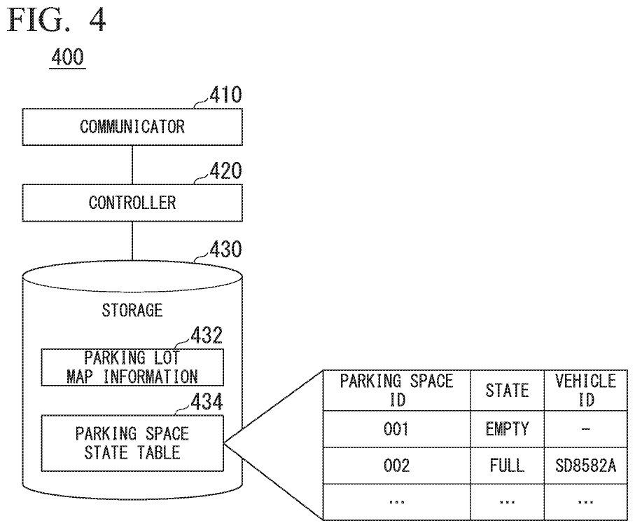

FIG. 4 is a diagram showing an example of the configuration of the parking lot management device 400. The parking lot management device 400 includes, for example, a communicator 410, a controller 420, and a storage 430. The storage 430 stores information such as parking lot map information 432 and a parking space state table 434.

The communicator 410 wirelessly communicates with the host vehicle M and other vehicles. The controller 420 guides the vehicle to parking space PS on the basis of information acquired by the communicator 410 and information stored in the storage 430. The parking lot map information 432 is information geometrically indicating structures of the parking lot PA. The parking lot map information 432 includes coordinates for each parking space PS. In the parking space state table 434, for example, a state which is an empty state or a full (parked) state and a vehicle ID which is identification information of a vehicle during parking in the case of the full state are associated with a parking space ID which is identification information of the parking space PS.

When the communicator 410 receives a parking request from the vehicle, the controller 420 extracts the parking space PS whose state is the empty state with reference to the parking space state table 434, acquires a position of the extracted parking space PS from the parking lot map information 432, and transmits a suitable route to the acquired position of the parking space PS to the vehicle using the communicator 410. The controller 420 instructs a specific vehicle to stop or slow down as necessary so that vehicles do not move to the same position at the same time on the basis of positional relationships of a plurality of vehicles.

In the vehicle receiving the route (hereinafter, referred to as the host vehicle M), the self-traveling parking controller 142 generates a target trajectory based on the route. When the host vehicle M approaches the target parking space PS, the parking space recognizer 132 recognizes parking slot lines that partition the parking space PS and the like, recognizes a detailed position of the parking space PS, and provides the recognized position to the self-traveling parking controller 142. The self-traveling parking controller 142 receives the provided position to correct the target trajectory and cause the host vehicle M to be parked in the parking space PS.

### [Self-Traveling Parking Event-Time of Leaving]

The self-traveling parking controller 142 and the communication device 20 also maintain the operating state when the host vehicle M has been parked. For example, when the self-traveling parking controller 142 has received a pick-up request from a terminal device of an occupant by means of the communication device 20, the self-traveling pick-up controller 144 causes a self-traveling pick-up event of the host vehicle M to be activated. The self-traveling pick-up controller 144 activating an automated pick-up event causes the host vehicle M to be moved to the stopping area 310 and stopped at the stop position. At this time, the self-traveling pick-up controller 144 controls the communication device 20 so that the communication device 20 transmits the pick-up request to the parking lot management device 400. The controller 420 of the parking lot management device 400 instructs a specific vehicle to stop or slow down as necessary so that vehicles do not move to the same position at the same time on the basis of a positional relationship of a plurality of vehicles as in the entering process. When the host vehicle M is moved to the stop position within the stopping area 310 and allows the occupant to get thereinto, the operation of the self-traveling pick-up controller 144 is stopped and manual driving or automated driving by another functional part is subsequently started.

The self-traveling parking controller 142 may find an empty parking space on its own on the basis of a detection result of the camera 10, the radar device 12, the finder 14, or the physical object recognition device 16 independently of communication and cause the host vehicle M to be parked within the found parking space without being limited to the above description.

### [Self-Traveling Parking Event-First Action]

The action recognizer 134 refers to first action reference information and recognizes that the user Y is executing (or “has executed”) (the term “has executed” will be hereinafter omitted) a first action on the basis of a detection result of the detector such as the camera 10. For example, the first action reference information is preregistered in the storage area of the first controller 120 for each user (or each vehicle). The first action reference information includes information obtained by defining a human action (including an operation, a gesture, and the like) representing the first action.

The first action is an example of a predetermined motion associated with the opening control by the user. The first action is an action for instructing the host vehicle M to automatedly open the door, and includes, for example, a gesture of opening the door, a gesture of beckoning, a gesture of waving a hand, and the like. Because the first action is also an action for causing the host vehicle M to authenticate a user Y preregistered as a user of the host vehicle M, an action that is unlikely to be performed by a normally walking pedestrian or a normally standing person, such as, for example, a gesture of moving a hand or an arm in a complicated manner, or an unnatural motion of the whole body, may be added. The first action may be moving a line of sight, moving a mouth, moving a preregistered item (for example, an electronic key or the like), or the like.

When it is recognized that the user Y is executing the first action while the host vehicle M is automatedly traveling, the following processes (11) to (14) are executed. In this case, for example, a scene in which the user Y arrives at the getting-into/out area 320 and the leaving host vehicle M goes to the stopping area 310 according to unmanned traveling is included.

(11) When the host vehicle M has recognized a person who is executing the first action during the automated traveling, the action recognizer 134 authenticates that the person is the user Y of the host vehicle M. That is, the action recognizer 134 authenticates that the person who is executing the first action is the user.

The action recognizer 134 may authenticate the user Y of the host vehicle M using technology of face authentication based on preregistered feature information or the like without being limited thereto. For example, the action recognizer 134 acquires a face image of a person who is executing the first action and determines whether or not the person is the preregistered user Y using the technology of face authentication. When it is authenticated that the person who is executing the first action is the user Y, the action recognizer 134 determines that the user Y has issued an instruction for automatedly opening the door. A timing at which the face authentication is performed is not limited to a timing after the first action is executed and may be a timing before the first action is executed.

The action recognizer 134 derives a position of the authenticated user Y or a distance between the authenticated user Y and the host vehicle M on the basis of a detection result of the physical object recognition device 16 and the like. Because a positional relationship between the host vehicle M and the user Y changes due to the traveling of the host vehicle M and the movement of the user Y, the action recognizer 134 may derive a position of the user Y and a distance from the user Y at predetermined intervals.

(12) When the action recognizer 134 recognizes that the user Y is executing the first action while the host vehicle M is automatedly traveling, the door controller 168 performs opening control for opening the door of the host vehicle M. The opening control includes unlocking the door and opening the unlocked door.

When the door is a hinged door, the door controller 168 performs opening control for bringing the door into a half-closed state. The half-closed state is a state in which the door is unlocked and a state in which the door can be opened outward by pulling the door (for example, a state in which the closed state of a member for maintaining the door in the closed state is released). When the door is unlocked, a part of the door may come out. The hinged door is, for example, a door that is opened when the door moves outward about a fulcrum.

When the door is a hinged door and a passenger in the host vehicle M is recognized by the occupant recognition device 90, the door controller 168 may perform opening control for unlocking the door without opening the door outward. Thereby, it is possible to prevent the door from moving in a situation in which the passenger is already present.

When the door is a sliding door, the door controller 168 performs opening control for bringing the door into a fully-open state or a half-open state. The door controller 168 may perform the opening control for setting the vehicle in the fully-open state when the vehicle has arrived at the stop position after setting the vehicle in the half-open state without being limited thereto. The fully-open state is a state in which the door is maximally opened. By making the door be in the fully-open state, the user can get into the vehicle smoothly. The half-open state is a state in which the door is not maximally opened. An amount of movement of the door in the half-open state (a degree at which the door is opened and the inside of the vehicle is visible) may be determined by the user Y or may be a default value. For example, when the user Y does not want to show the inside of the vehicle, the door may be moved by a few centimeters, or the door may be moved by several tens of centimeters so that the user Y can get into the vehicle alone. By making the door be in the half-open state, it is possible to meet the intention of the user Y who does not want to show the inside of the vehicle to others and it is possible to prevent the cold air (or warm air) in the vehicle from leaving by excessively opening the door. When it is difficult for the user Y to get into the vehicle in the half-open state, the user Y can manually open the door. The sliding door is, for example, a door that is opened and closed when the door moves along the vehicle body.

When the door is a sliding door and the passenger in the host vehicle M is recognized by the occupant recognition device 90, the door controller 168 may unlock the door and perform opening control without moving the door. Thereby, it is possible to prevent the door from moving in a situation in which the passenger is already present.

The self-traveling pick-up controller 144 determines a timing at which the opening control starts so that the opening control is completed before the host vehicle M arrives at the stop position at the latest on the basis of the positional relationship between the host vehicle M and the user Y and the like. For example, the self-traveling pick-up controller 144 may determine that the opening control is to be immediately started when it is recognized that the user Y is performing the first action or determine that the opening control is to be started so that the opening control is completed when the host vehicle M has arrived at a meeting point to which the user Y moves. Thereby, when the host vehicle M arrives at the stop position, the door is unlocked and the user Y can save time and effort in unlocking the door. When the host vehicle M arrives at the stop position, the user can smoothly get into the host vehicle M because the hinged door is in the half-closed state and the sliding door is in the fully-open state or the half-open state.

When the host vehicle M arrives at the stop position earlier than the user Y and waits for the arrival of the user Y, the self-traveling pick-up controller 144 may determine to start the opening control in accordance with a timing at which the user Y approaches or may determine a start timing of the opening control so that the opening control is completed at a timing when the user Y arrives at the stop position. In the former case, when the action recognizer 134 recognizes that a distance between the user Y and the host vehicle M is less than or equal to a threshold value, the self-traveling pick-up controller 144 determines that the timing is a timing when the user Y approaches. In the latter case, the self-traveling pick-up controller 144 derives the timing when the user Y arrives at the stop position on the basis of a walking speed of the user Y, a distance between the user Y and the host vehicle M derived by the action recognizer 134, or the like and performs back calculation on a timing when the opening control starts. The door controller 168 starts the opening control when the self-traveling pick-up controller 144 determines that the timing is a start timing of the opening control.

A case in which the host vehicle M arrives at the stop position earlier than the user Y may include a case in which the host vehicle M is predicted to arrive at the stop position earlier than the user Y. The self-traveling pick-up controller 144 can derive the timing at which the user Y arrives at the stop position on the basis of a recognition result of the recognizer 130 and the like and can determine which of the user Y and the host vehicle M arrives at the stop position first.

(13) When the action recognizer 134 recognizes that the user Y is executing the first action while the host vehicle M is automatedly traveling, the self-traveling pick-up controller 144 determines any position within the stopping area 310 as a stop position P1 and causes the host vehicle M to travel toward the stop position P1. The stop position P1 is an empty space within the stopping area 310, a center of the stopping area 310 in the longitudinal direction, a space within the stopping area 310 closest to a gate of the visiting destination facility, and the like. The stop position P1 may be determined before the first action is recognized or may be determined regardless of whether or not the first action has been recognized.

(14) When the action recognizer 134 recognizes that the user Y is executing the first action while the host vehicle M is automatedly traveling, the self-traveling pick-up controller 144 may cause behavior indicating that the host vehicle M approaches the user Y to be started. The behavior indicating that the host vehicle M approaches the user Y includes, for example, turning on a direction indicator, blinking a headlight, blinking a tail lamp, outputting a message by sound, and the like. Thereby, the user Y can determine that the host vehicle M has recognized the first action.

### [Self-Traveling Parking Event-Second Action]

The action recognizer 134 refers to the second action reference information and recognizes that the user Y is executing the second action on the basis of a detection result of the detector such as the camera 10. The second action is an action for indicating a stop position of the host vehicle M to the host vehicle M. When it is recognized that the user Y is executing the second action, the self-traveling pick-up controller 144 changes the stop position on the basis of instruction details of the second action.

The second action reference information is registered in the storage area of the first controller 120 and is information common to a plurality of users and a plurality of vehicles. The second action reference information may be different information for each user (or for each vehicle) without being limited thereto. The second action reference information is information in which information defining a human action (including an action, a gesture, and the like) representing the second action is associated with information indicating details of the second action.

For example, a pose indicating the stop position is associated with the instruction details of the second action indicating that “the user Y indicates and designates the stop position”. Instruction details of the second action indicating that “a current position of the user Y is designated as the stop position” is associated with a pose in which his or her palm stands upright. Instruction details of the second action indicating that “the host vehicle M is stopped in a place where no other vehicle is stopped in the stopping area 310” include an action of turning a fingertip around. This is effective when the stopping area 310 is congested with other vehicles. Instruction details of the first action may include a case in which the host vehicle M stops before the user Y, a case in which the host vehicle M stops next to the user Y, a case in which the host vehicle M stops after passing the user Y, and the like without being limited thereto.

The second action may be an action in which the user Y approaches the host vehicle M. In this case, instruction details may be, for example, designating a meeting point to which the moving user Y moves as a stop position or designating a stop position within a predetermined range on the basis of the meeting point. The self-traveling pick-up controller 144 causes the host vehicle M to travel toward the determined stop position. Thereby, when the user Y forgets to execute the second action, the stop position can also be changed on the basis of the position of the user Y.

The second action may be an action in which the user Y is standing or an action in which the user Y raises his or her leg or moves his or her leg sideways. In this case, the instruction details of the second action may be, for example, designating the current position of the user Y as the stop position, and designating the stop position within a predetermined range on the basis of the current position of the user Y. Thereby, when an action using hands of the user Y, such as when the user Y has luggage or when the user Y has a child or an animal in his or her arms, is difficult, the stop position can also be changed on the basis of the position of the user Y.

The action recognizer 134 makes the recognition accuracy of the first action higher than that of the second action. For example, the action recognizer 134 recognizes the second action using pattern recognition technology and recognizes the first action using deep learning technology having higher recognition accuracy than the pattern recognition technology. In other words, increasing the recognition accuracy may mean increasing the number of processing steps. The action recognizer 134 may increase the threshold value when the first action is recognized so that recognition is difficult as compared with when the second action is recognized without being limited thereto. Thereby, the authentication accuracy of the user Y can be secured and the second action can be easily authenticated.

When it is recognized that the second action has been executed by the user Y, the following processes (21) and (22) are executed.

(21) When the action recognizer 134 recognizes that the user Y has executed the second action during the automated traveling of the host vehicle M, the self-traveling pick-up controller 144 changes the stop position on the basis of the instruction details of the second action. For example, when the stop position P1 determined when the first action is recognized is different from a stop position P2 designated by the user Y in the second action, the self-traveling pick-up controller 144 changes a place in which the host vehicle M is stopped from the stop position P1 to the stop position P2.

(22) When the stop position is changed on the basis of the instruction details of the second action, the self-traveling pick-up controller 144 may determine a start timing of the opening control so that the opening control is completed at the timing when the host vehicle M arrives at the stop position. Thereby, because it is possible to shorten a period of unmanned traveling in the unlocked state, it is possible to prevent an accident such as another person getting into the vehicle. Because the opening control can be completed at the same time when the host vehicle M arrives at the stop position, the user Y can be prompted to get into the host vehicle M.

When the user Y recognizes that the second action has not been executed, the following processes (31) and (32) are executed.

(31) For example, if the second action is not recognized until a predetermined time period has elapsed from a timepoint when the first action has been recognized, the self-traveling pick-up controller 144 determines the stop position on the basis of the position of the user Y. If the second action is not executed by the user Y until the host vehicle M arrives at the stop position P1 determined when the first action is recognized, the self-traveling pick-up controller 144 may determine that the stop position is not changed.

(32) For example, when the second action is not recognized and the action recognizer 134 recognizes a situation in which the user Y cannot free his or her hands, the self-traveling pick-up controller 144 may change the stop position determined in accordance with the position of the user Y to a position close to the user Y as compared with a case in which a situation in which the user Y cannot free his or her hands is not recognized. The situation in which the user Y cannot free his or her hands includes a situation in which the user Y has luggage or has a child or an animal in his or her arms, and the like. For example, in the situation in which the user Y cannot free his or her hands, it is predicted that the user Y does not move from his or her current position. The self-traveling pick-up controller 144 changes the stop position to a space closest to the current position of the user Y among available stopping spaces in the stopping area 310. On the other hand, when the situation is not the situation in which the user Y cannot free his or her hands, it is predicted that the user Y will walk toward the host vehicle M. The self-traveling pick-up controller 144 may give priority to a space where the host vehicle M is easily stopped among available stopping spaces of the stopping area 310 and change the stop position to a space several meters away from the current position of the user Y.

The self-traveling pick-up controller 144 may find a stopping space which is closest to the stop position and is a place where other vehicles are not stopped within the stopping area 310 on its own on the basis of a detection result of the camera 10, the radar device 12, the finder 14, or the physical object recognition device 16 and cause the host vehicle M to be stopped within the found stopping space without being limited to the above description.

The self-traveling pick-up controller 144 may determine the stop position on the basis of a position of the user Y derived by the action recognizer 134, a traveling speed of the host vehicle M, other recognition results of the recognizer 130, and the like.

### [Example of Pick-Up Scene]

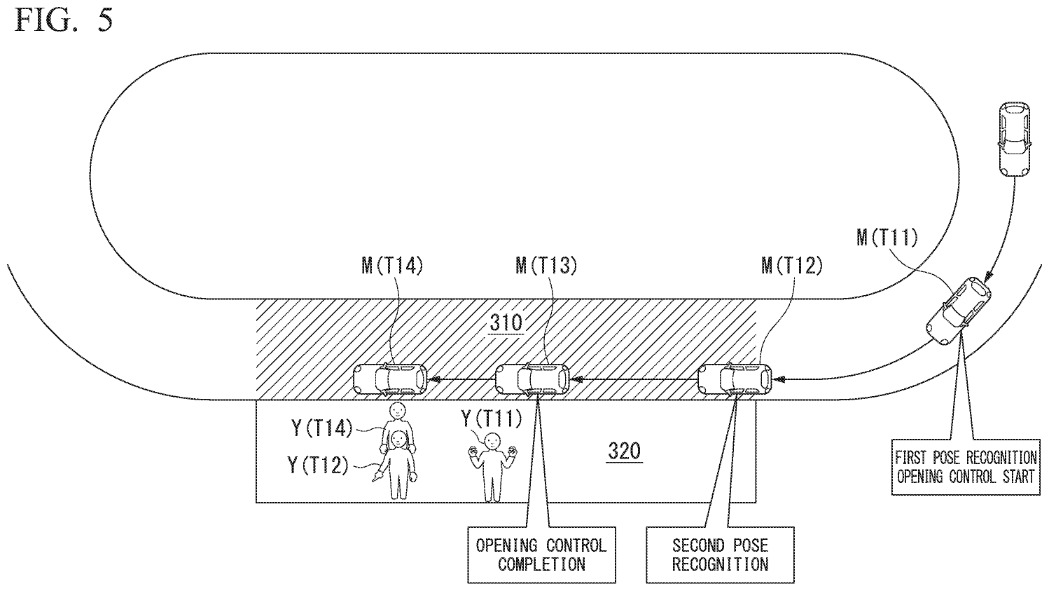

FIG. 5 is a diagram showing an example of a scene in which the user Y gets into the host vehicle M. The host vehicle M leaving the parking lot PA travels toward the stopping area 310 in an unmanned manner. At time T11, it is assumed that the user Y executes the first action and the host vehicle M recognizes the user Y who executes the first action. In this case, the host vehicle M starts the opening control, determines any position in the stopping area 310 as the stop position, and travels toward the stop position. In this example, because there is no other vehicle stopped in the stopping area 310, it is assumed that the center of the stopping area 310 in the longitudinal direction is determined to be the stop position.

At time T12, it is assumed that the user Y executes the second action and the host vehicle M recognizes that the second action has been executed by the user Y. In this case, the host vehicle M changes the stop position on the basis of instruction details of the second action. For example, when the current position of the user Y is not the center of the stopping area 310 in the longitudinal direction that is the current stop position, the host vehicle M changes the stop position to the position within the stopping area 310 closest to the current position of the user Y.

At time T13, the opening control is completed, the host vehicle M is unlocked, and, for example, the sliding door is fully opened. At time T14, the host vehicle M arrives at the stop position, and the user Y arrives before the host vehicle M. Thus, the user Y can get into the host vehicle M without performing any operation.

### [Operation Flow]

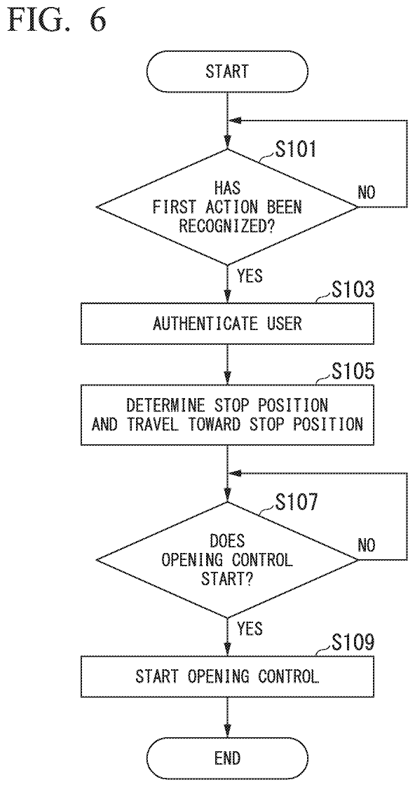

FIG. 6 is a flowchart showing an example of a process associated with the first action. First, the action recognizer 134 recognizes a person who executes the first action on the basis of a detection result of the detector such as the camera 10 (step S101). When a person who executes the first action has been recognized, the action recognizer 134 authenticates that the person who executes the first action is the user Y (step S103).

The self-traveling pick-up controller 144 determines any position within the stopping area 310 as the stop position P1 and travels toward the stop position P1 (step S105). Here, the self-traveling pick-up controller 144 may cause an action (behavior) indicating that the host vehicle M approaches the user Y to be started. Next, when a timing of the start of the opening control has been reached (step S107), the door controller 168 starts the opening control (step S109). The timing of the start of the opening control is determined by the self-traveling pick-up controller 144 according to the various methods described above.

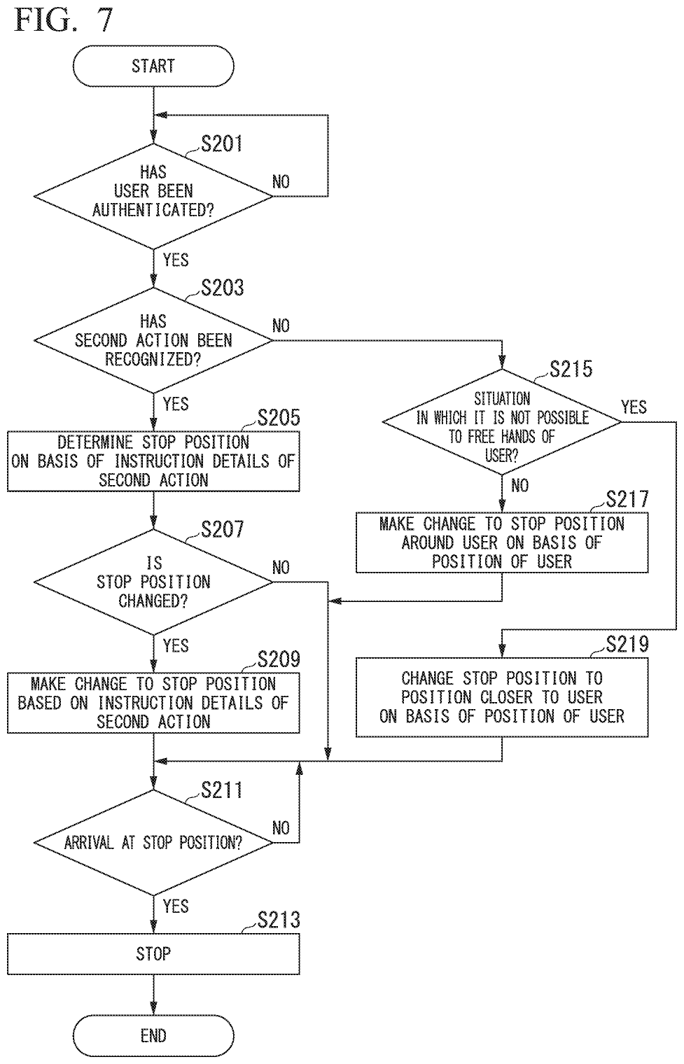

FIG. 7 is a flowchart showing an example of a process associated with the second action. First, when the user Y is authenticated (step S201), the action recognizer 134 determines whether or not the user Y has executed the second action on the basis of the detection result of the detector such as the camera 10 (step S203). When it is recognized that the second action has been executed by the user Y in step S203, the self-traveling pick-up controller 144 determines the stop position P2 on the basis of instruction details of the second action (step S205). If the stop position P1 is different from the stop position P2 (step S207), the self-traveling pick-up controller 144 changes a position where the host vehicle M is stopped to the stop position P2 (step S209). Subsequently, when the host vehicle M has arrived at the stop position (step S211), the self-traveling pick-up controller 144 causes the host vehicle M to be stopped (step S213).

On the other hand, when it is recognized that the second action has not been executed by the user Y in step S203, the action recognizer 134 determines whether or not the situation is a situation in which the user Y cannot free his or her hands on the basis of the detection result of the detector such as the camera 10 (step S215). The situation in which the user Y cannot free his or her hands is a state in which both hands of the user Y are closed, and includes, for example, holding luggage in both hands of the user Y, holding a child or an animal in the arms of the user Y, and the like. When the situation is not the situation in which the user Y cannot free his or her hands, the self-traveling pick-up controller 144 changes the stop position on the basis of the current position of the user Y (step S217). For example, when a distance between a current position P3 of the user Y and the stop position P1 determined by the recognition of the first action is greater than or equal to a predetermined distance, the self-traveling pick-up controller 144 changes a position where the host vehicle M is to be stopped to a stop position P4 around the user Y on the basis of the current position P3 of the user Y. For example, the self-traveling pick-up controller 144 determines any position within a range of a radius R1 around the current position P3 of the user Y (a space where the host vehicle M can be easily parked or the like) as the stop position P4.

On the other hand, when the user Y cannot free his or her hands in step S215, the self-traveling pick-up controller 144 changes the stop position on the basis of the current position of the user Y (step S219). For example, when a distance between the current position P3 of the user Y and the stop position P1 determined by the recognition of the first action is greater than or equal to a predetermined distance, the self-traveling pick-up controller 144 changes a position where the host vehicle M is stopped to a stop position P5 closer to the user on the basis of the current position P3 of the user Y. For example, the self-traveling pick-up controller 144 may determine any position (such as a space where the host vehicle M can be easily parked) within a range of a radius R2 (R2<R1) around the current position P3 of the user Y as the stop position P5.

As described above, the automated driving control device 100 of the present embodiment includes a detector configured to detect a situation outside a vehicle; a recognizer configured to recognize a surrounding environment of the vehicle on the basis of a detection result of the detector; a driving controller configured to perform at least one of speed control and steering control of the vehicle on the basis of a recognition result of the recognizer; and a door controller configured to perform opening control for opening a door of the vehicle, wherein the door controller starts the opening control for opening the door of the vehicle if the recognizer has recognized a predetermined motion of a user when the vehicle travels according to control of the driving controller, so that the door is unlocked when the host vehicle M has arrived at the stop position and the user

Y can save time and effort in unlocking the door. When the host vehicle M arrives at the stop position, the user can get into the host vehicle M smoothly because the hinged door is in the half-closed state and the sliding door is in the fully-open state or the half-open state. Consequently, the convenience of the user who gets into the vehicle that has traveled can be improved.

### [Hardware Configuration]

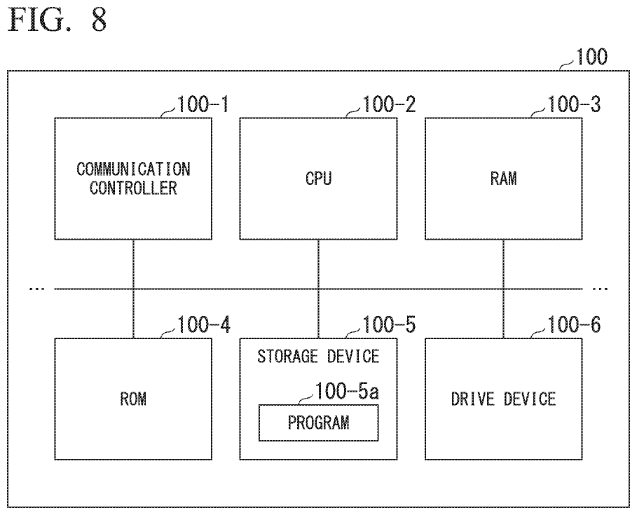

FIG. 8 is a diagram showing an example of a hardware configuration of the automated driving control device 100 of the embodiment. As shown in FIG. 8, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are mutually connected by an internal bus or a dedicated communication line. The communication controller 100-1 communicates with components other than the automated driving control device 100. The storage device 100-5 stores a program 100-5a to be executed by the CPU 100-2. This program is loaded to the RAM 100-3 by a direct memory access (DMA) controller (not shown) or the like and executed by the CPU 100-2. Thereby, one or both of the first controller 120 and the second controller 160 are implemented.

The embodiment described above can be represented as follows.

A vehicle control device including:

a storage device configured to store a program;

a hardware processor; and

a detector configured to detect a situation outside a vehicle,

wherein the hardware processor executes the program stored in the storage device to:

recognize a surrounding environment of a vehicle on the basis of a detection result of the detector;

perform at least one of speed control and steering control of the vehicle on the basis of a recognition result; and

start opening control for opening a door of the vehicle if a predetermined motion of a user has been recognized.

Although modes for carrying out the present invention have been described using embodiments, the present invention is not limited to the embodiments, and various modifications and substitutions can also be made without departing from the scope and spirit of the present invention.

For example, although it is assumed that the host vehicle M approaches the user according to unmanned traveling at the time of leaving in valet parking, the present invention is not limited thereto. For example, when the next user gets into the vehicle in a state in which a first user gets into the vehicle in the case of vehicle-sharing, the case in which users meet together in a vehicle, or the like, the first action may be recognized during manned traveling and opening control may be started.

What is claimed is:

1. A vehicle control device comprising:
a recognizer configured to recognize a surrounding environment of a vehicle on the basis of a detection result of a detector configured to detect a situation outside the vehicle;
a driving controller configured to perform at least one of speed control and steering control of the vehicle on the basis of a recognition result of the recognizer; and
a door controller configured to perform opening control for opening a door of the vehicle,
wherein the door controller starts the opening control for opening the door of the vehicle if the recognizer has recognized a predetermined motion of a user when the vehicle travels according to control of the driving controller.

2. The vehicle control device according to claim 1,
wherein the driving controller starts an action representing that the vehicle approaches the user when the recognizer has recognized a first action of the user associated with the opening control, and
wherein the driving controller changes a stop position determined in accordance with a position of the user on the basis of a second action when the recognizer has recognized the second action different from the first action of the user after the action representing that the vehicle approaches the user started.

3. The vehicle control device according to claim 2,
wherein the first action is an action for causing the vehicle to authenticate a person preregistered as a user of the vehicle, and
wherein the second action is an action for indicating a stop position of the vehicle to the vehicle.

4. The vehicle control device according to claim 2,
wherein the second action includes a motion of the user approaching the vehicle.

5. The vehicle control device according to claim 2,
wherein the recognizer improves recognition accuracy of the first action as compared with the second action.

6. The vehicle control device according to claim 2,
wherein the driving controller changes the stop position on the basis of the position of the user when the recognizer has not recognized the second action.

7. The vehicle control device according to claim 2,
wherein, when the stop position is changed on the basis of the second action, the door controller causes the opening control to be completed at a timing when the vehicle arrives at the changed stop position.

8. The vehicle control device according to claim 2,
wherein, when the second action is not recognized and the recognizer recognizes that the user has luggage or has a human or animal in his or her arms, the driving controller changes the stop position determined in accordance with the position of the user.

9. The vehicle control device according to claim 1,
wherein, when the vehicle has arrived at the stop position earlier than the user, the door controller starts the opening control at a timing when the user has approached the vehicle.

10. The vehicle control device according to claim 1,
wherein, when the door is opened by moving outward about a fulcrum, the door controller unlocks the door and puts the door in a half-closed state.

11. The vehicle control device according to claim 1,
wherein, when the door is opened or closed by moving along a vehicle body of the vehicle, the door controller unlocks the door and moves the door by a predetermined amount.

12. The vehicle control device according to claim 11,
wherein, when an occupant recognition device mounted on the vehicle has recognized a passenger of the vehicle, the door controller unlocks the door and does not move the door.

13. A vehicle control method comprising:
recognizing, by a computer mounted on a vehicle, a surrounding environment of the vehicle on the basis of a detection result of a detector configured to detect a situation outside the vehicle;
performing, by the computer mounted on the vehicle, at least one of speed control and steering control of the vehicle on the basis of a recognition result; and
starting, by the computer mounted on the vehicle, opening control for opening a door of the vehicle if a predetermined motion of a user has been recognized.

14. A computer-readable non-transitory storage medium storing a program for causing a computer mounted on a vehicle to:
recognize a surrounding environment of the vehicle on the basis of a detection result of a detector configured to detect a situation outside the vehicle;
perform at least one of speed control and steering control of the vehicle on the basis of a recognition result; and
start opening control for opening a door of the vehicle if a predetermined motion of a user has been recognized.
